(19) United States
(12) Patent Application Publication
(10) Pub. No.: US 2003/0103872 A1
(43) Pub. Date: Jun. 5, 2003

(54) Device and method for preparing and carrying out nmr measurements of samples

(76) Inventors: Walter Maier, Mannheim (DE); Johannes Zerweck, Berlin (DE); Michael Grull, Neustadt (DE); Joachim Richert, Rodersheim-Gronau (DE)

Correspondence Address: KEIL & WEINKAUF, 1350 CONNECTICUT AVENUE, N.W., WASHINGTON, DC, 20036, US

(21) Appl. No.: 10/240,679

(22) PCT Filed: Apr. 2, 2001
(86) PCT No.: PCT/EP01/03730

(30) Foreign Application Priority Data
Apr. 3, 2000 (DE) 100 16 568.0

(51) Int. Cl. B32B 5/02; B32B 27/12; B32B 27/04; G01N 27/00

(52) U.S. Cl. 422/82.01

(57) ABSTRACT

A process and an apparatus for preparing and carrying out NMR measurements on substrate samples (3.1), individual solutions of the substrate samples (3.1) being prepared by means of a pipetting system (1) and being fed to a flow cell (16) for preparation and carrying out of NMR measurements, it being possible to flush the feed apparatus (7) and the pipetting system (1) with at least one solvent (8, 9) are described. A workstation (54) recording the NMR spectrum of the sample and a computer (53) controlling the pipetting system (1) access a common directory tree (32) which contains directories (33.1 to 33.9) with files which define the samples and are called up in such a way as to ensure that the directories (33.1 to 33.9) are worked through in a time-interleaved manner.

The present invention relates to an apparatus and a process for carrying out the preparation and NMR measurement of samples, comprising a pipetting system and an NMR spectrometer.

Injection NMR measuring systems are known in which the pipetting system constituting the handling apparatus is used as the sample changer for the spectrometer. During routine operation of the handling apparatus, it is essential to check, after every measurement, the cleanliness of a flow cell in which the spectroscopic measurement is effected. For this purpose, after the FID (free induction decay) of the respective sample to be measured has been recorded and the flow cell has been flushed, an FID of the flushed flow cell, too, is recorded. This recorded spectrum is compared with a reference spectrum of the solvent used in each case. If the same number of signals or fewer signals occur in the clean spectrum compared with the reference spectrum, the flow cell is certain to be clean and the next sample can be injected into the flow cell. If more signals occur in the measured clean spectrum than in the reference spectrum, the flow cell must be flushed again.

In the course of processing a sample various operations must be carried out. With regard to the handling apparatus, the preparation of the sample and the injection thereof into the sample loop, the transport of the sample from the sample loop into the flow cell in which the measurement takes place and the cleaning of the needle and the flushing of the flow cell must be effected. In the spectrometer, an FID of the sample and an FID of the empty, flushed flow cell are recorded. If the individual operations were to be carried out in succession, the required time span for processing a sample would be 375 s in the case of the solvent chloroform and 420 s where DMSO were used.

The required time spans for processing a respective sample mean that an evaluation of this type is uneconomical. The use of the handling apparatus only as a sequentially employed sample changer for a spectrometer is uneconomical with regard to the associated capital costs and ties up a great deal of capital.

In view of the disadvantages described, it is an object of the present invention to achieve better use of the hardware components of an NMR measuring system comprising a pipetting system and a spectrometer containing a flow cell for evaluation.

We have found that this object is achieved, according to the invention, if, in a process for preparing and carrying out NMR measurements on substrate samples, the substrate samples being handled by means of a pipetting system and being fed to a flow cell for recording an NMR spectrum and it being possible to flush the feed apparatus and the pipetting system with at least one solvent, a computing unit carrying out the evaluation of the NMR spectrum of the sample and a computer controlling the pipetting system access a common directory tree which contains directory files which are called up in such a way as to ensure that the directory files are worked through in a time-interleaved manner.

The advantages achievable by the process proposed according to the invention during operation of an NMR measuring system are in particular that it is now possible to carry out preparation procedures, such as dissolution of the sample, mixing and dilution of the sample, simultaneously with the recording of the measured data of the respective preceding sample which is already present in the spectrometer. The same applies to the required flushing procedures for the needle and for the injector port as soon as a new sample is prepared for the spectroscopy measurement in the flow cell.

By time-interleaving and resultant parallel processing of different samples, it is possible to reduce the processing time by up to 25%, for example for a sample dissolved in chloroform. If, on the other hand, a sample dissolved in the solvent DMSO is prepared by means of the process proposed according to the invention and is subjected to a measurement, the processing time can be reduced from 420 s to 340 s, which corresponds to a reduction of about 20%.

Furthermore, in the cleaning of the flow cell to remove residues of the preceding samples, the consumption of deuterated solvent can be reduced to 3000 μl by means of the proposed process. The consumption of protonated solvent is 3000 μl.

According to further embodiments of the concept on which the invention is based, the preparation step comprising dissolution of a further sample in the feed apparatus is carried out simultaneously with the recording of the measured data in the spectrometer. Furthermore, the flushing procedures for feed apparatus and injector port on the pipetting system are carried out simultaneously with the evaluation of the preceding sample in the spectrometer of the NMR measuring system. This time-interleaved procedure permits simultaneous operation of the spectrometer, the feed apparatus and the pump, so that the hardware components of an NMR measuring system operated in this manner are more uniformly utilized.

According to a development of the process proposed according to the invention for operating an NMR measuring system, a spectrum of the flushed flow cell is recorded before a fresh injection of a further substrate sample into the flow cell and said spectrum is compared with a reference spectrum of the solvent used. In this way, it is ensured that, after flushing of the flow cell, no residues of the sample measured in a preceding process step are present in the flow cell and falsify the result of the measurement of the new sample. Furthermore, if the spectra of the flushed flow cell correspond to the reference spectrum, a fresh injection of a subsequent sample is performed and, in the event of divergence of the spectra of flushed flow cell and reference spectrum of the flow cell, further flushing of the flow cell is initiated. By means of this procedure, it is ensured that residues of preceding samples are completely removed from the flow cell by flushing procedures for the flow cell which are performed depending on the result of the comparison, and said residues do not adversely affect subsequent measurements.

For interleaving the individual sample processing steps to be performed on pipetting system and spectrometer, the PC controlling the pipetting system together with the handling apparatus and the workstation evaluating the NMR spectra access a common directory tree which contains both sample files and flag files. By distributing the flag files within the directory tree, identification and more accurate producibility of the process steps performed and those still to be performed are ensured during measurement of a multiplicity of samples. According to a further embodiment of the process proposed according to the invention, the solvents, for example DMSO-d6 and CDC13, can be pumped in separate, closed circulations in a pipetting system, it being possible for a separate pump module to be coordinated with each closed solvent circulation. By means of this embodiment of the process proposed according to the invention, the resulting solvent losses are zero, so that, in a cost-efficiency consideration of the process, costs for replenishing lost solvent can now be excluded. Preferably, deuterated solvents, such as CDC13 or DMSO-d6, can be used as solvents in the process proposed according to the invention for operating an NMR measuring system.

Furthermore, the present invention proposes an apparatus for preparing and recording NMR spectra of substrate samples, the substrate samples being prepared by means of a pipetting system and being fed to a flow cell for recording an NMR spectrum, it being possible to flush the feed apparatus and the pipetting system with at least one solvent, and a directory tree which is accessed jointly by a control computer for the pipetting system and by an acquisition computer permitting the substrate samples to be worked through in a time-interleaved manner in feed apparatus, spectrometer and pump module, and the substrate samples being held in decks.

Owing to the chosen embodiment of the decks, it is possible to process up to 396 substrate samples having a bottle base diameter of 22 mm and a bottle height of 50 mm in one operation; the respective decks in which the substrate samples are held may contain two or more levels which can be accessed by the feed apparatus of the pipetting system. Consequently, no preparatory measures need be taken by the operator and it is merely necessary, after a deck of substrate samples has been worked through, to replace it by a deck equipped with new substrate samples, which incidentally can also be effected by means of a fully automatic loading system which cooperates with the pipetting system.

According to an advantageous development of the apparatus proposed according to the invention, an HPLC pump having an excess pressure control is provided both in the sample loop and in the spectrometer flow cell in order to shorten the injection times. Excess pressure control prevents an excessively sharp increase in the pressure and hence damage to the line and valve components present in the pipetting system.

Arranged downstream of the pump module which is contained in the pipetting system of the NMR measuring system are brake capillaries which correspond to the solvents used, for example chloroform or DMSO-d6 and, depending on the solvent used, may have a different diameter or a different length. Consequently, the different viscosities and flow behaviors of the solvents which are used and in which the samples are dissolved can be taken into account.

According to a further advantageous development of the apparatus proposed according to the invention, the sample decks are divided at least into two levels, the substrate containers being made in the individual sample decks and passages for penetration by the feed apparatus being provided between the decks so that access to the substrate samples contained in the lower decks is ensured.

Furthermore, in the apparatus proposed according to the invention, flushing stations for the interior and the exterior of the feed apparatuses are provided, by means of which it is possible to initiate solvent flow which can be applied, so that, in addition to cleaning of the flow cell, cleaning of the feed apparatus on changing the substrate sample material is also ensured. As a result of the modification of the flushing station, the needle used for preparation can be both cleaned with deuterated solvent and sprayed off with protonated solvent. By cleaning the feed apparatus, which may be, for example, in the form of a steel needle having a tiny orifice, it is ensured that a further substrate sample is not contaminated by residues of a preceding substrate sample on the feed apparatus, with the result that the spectrum to be measured in the flow cell would be considerably adversely affected.

In a further embodiment of the present invention, the needle receiving the respective sample substrate can hold a wipable disposable filter element, which can be removed from the tip of the feed apparatus, which is in the form of a needle, in the course of a vertical movement of the feed apparatus through a slot-like orifice, during the upward movement of the feed apparatus.

Finally, the solvents, which are preferably deuterated solvents, such as chloroform or DMSO-d6, can each circulate in closed solvent circulations, each of which is coordinated with a pump module which feeds the solvents in a solvent-specific manner to brake capillaries of different lengths. As a result of the separation of the solvent circulations from one another, on the one hand a specific treatment of the solvent with respect to its viscosity is possible through the design of the brake capillary and, on the other hand, the solvent losses within the pump circulations, for example due to flushing, can be reduced to zero by the closed solvent circulations each equipped with separate pump modules, so that the ongoing costs for replenishing the solvent losses approach zero in a pipetting system of this type.

The invention is explained in more detail below with reference to a drawing, in which:

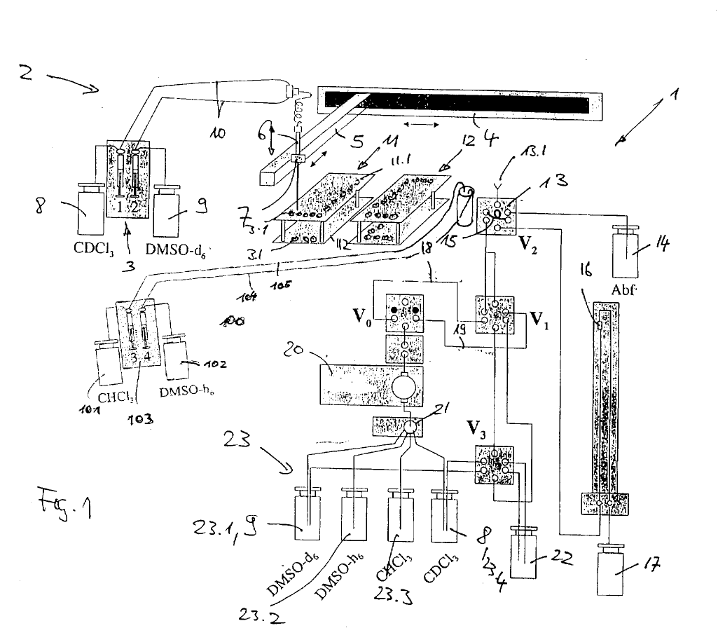

FIG. 1 shows a schematic structure of a pipetting system together with sample deck, flow cell and valves V0, V1, V2 and V3 connecting the line systems,

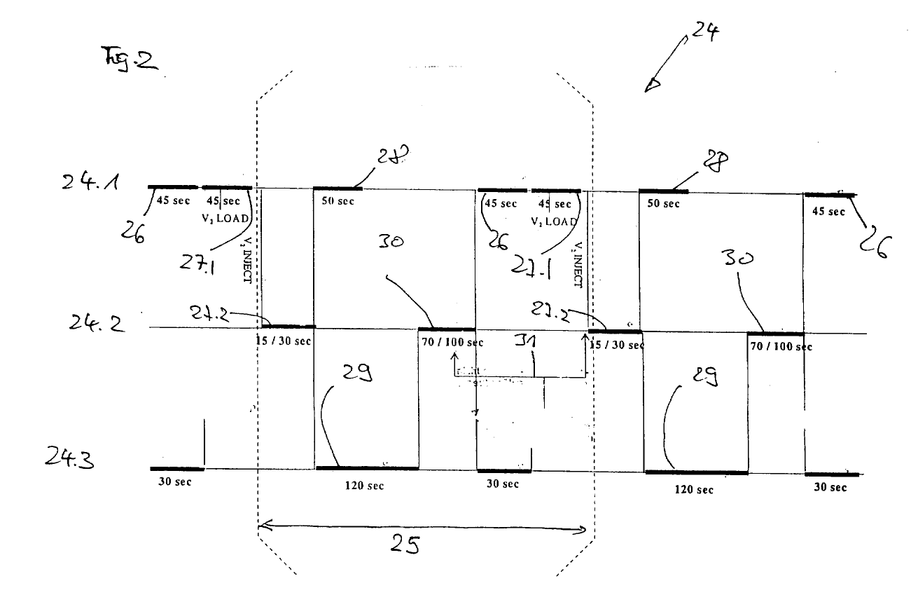

FIG. 2 shows the time-interleaving of the operating sequences of pipetting needle, pump module and spectrometer during the processing of two successive substrate samples,

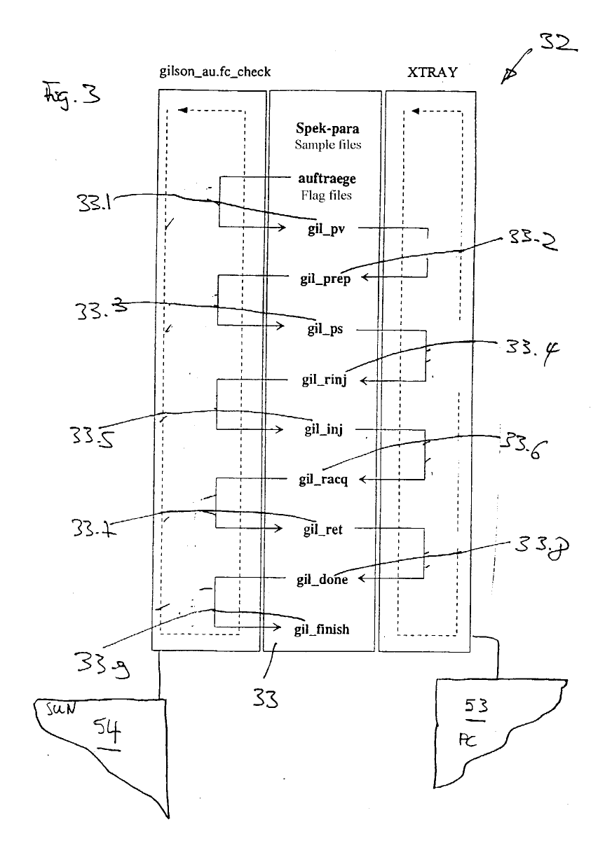

FIG. 3 shows a common directory structure for communication between the computer controlling the pipetting system and the acquisition computer for evaluating the NMR spectra,

FIG. 3 shows a detailed view of the needle used,

FIGS. 5.1-5.4 show detailed views of the valves V0, V1, V2 and V3 used in each case, which connect different regions of the pipetting system,

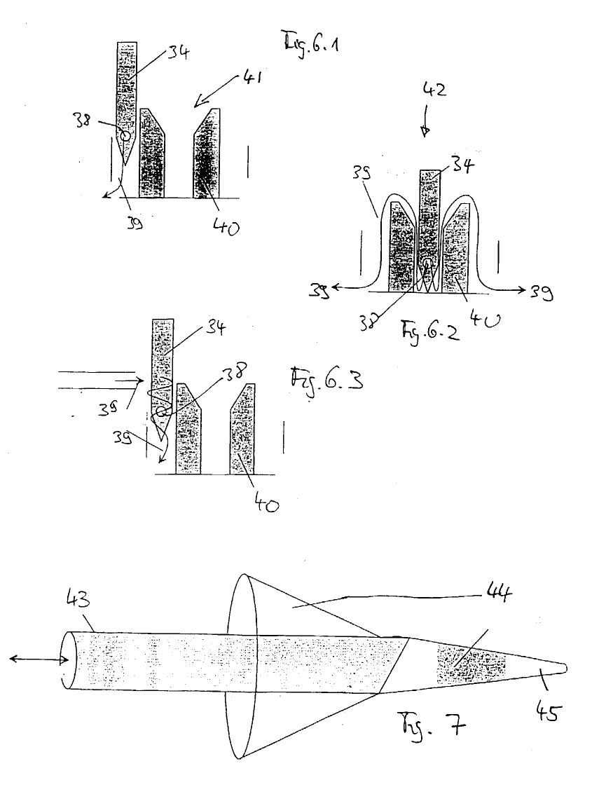

FIGS. 6.1-6.3 shows flushing positions of the needle used for preparation, 6.1 and 6.2 showing a commercially available flushing station and 6.3 the modified flushing station,

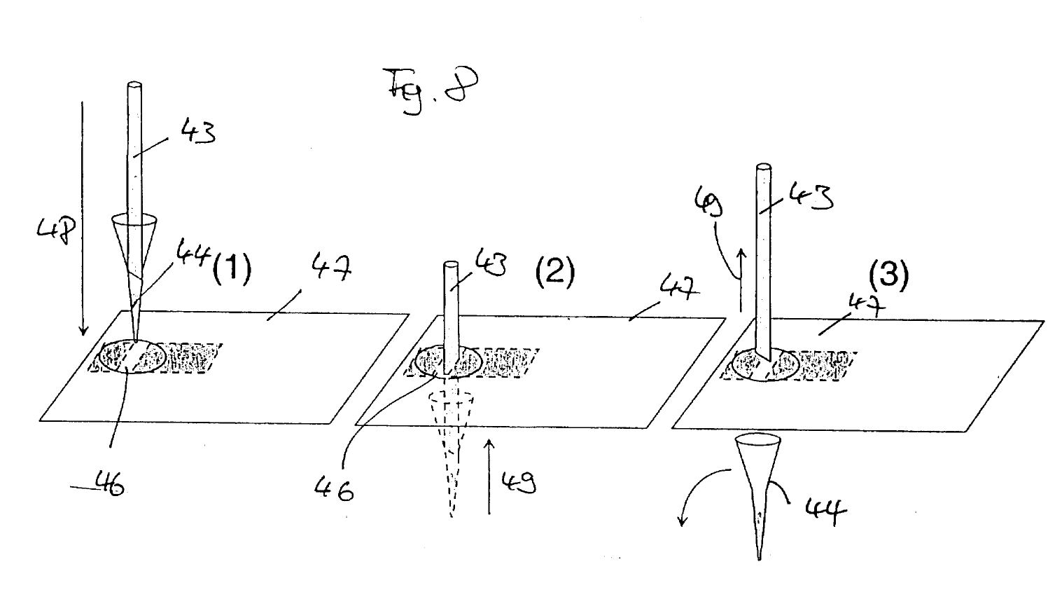

FIG. 7 shows a view of a beveled needle with mounted disposable filter system,

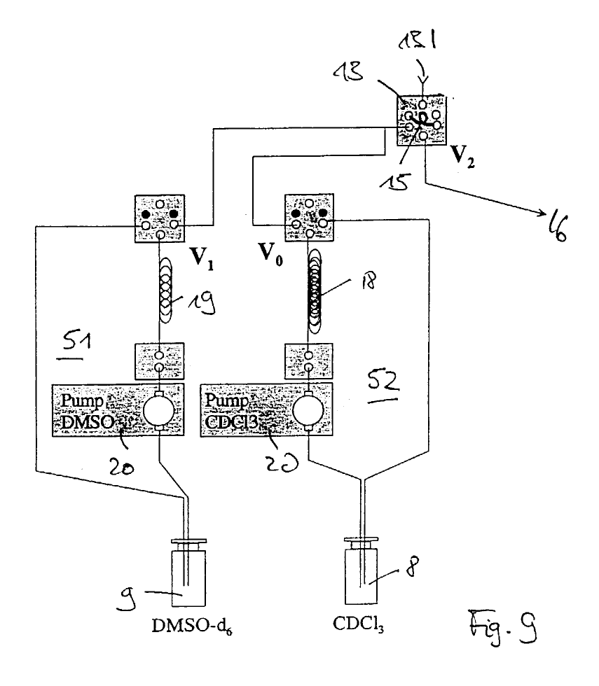

FIG. 8 shows a wiping station for the filter tip according to

FIG. 7 for the position of the filter on the needle (1), the position of the needle in the ejection station (2) and the wiped filter tip (3),

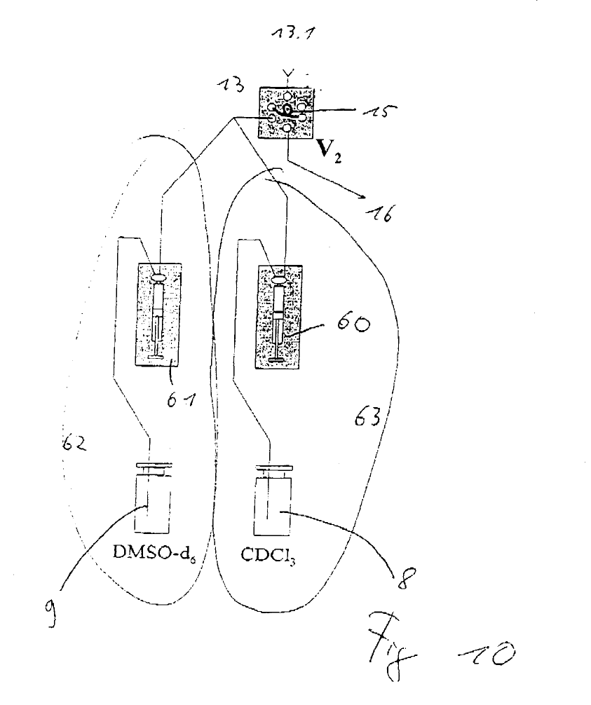

FIG. 9 shows a pipetting system comprising pump circulations separated from one another and intended for solvent circulation within the measuring system without solvent losses, and

FIG. 10 shows two pump circulations comprising two piston pumps connected in parallel.

The view according to FIG. 1 shows the schematic structure of a pipetting system together with substrate sample deck, flow cell and valves V0, V1, V2 and V3 each connecting the line system sections.

The pipetting system 1 according to the view in FIG. 1 contains a frame 2 and a pump module 3. Provided on the frame 2 is a robot arm 4 which holds a further robot arm 5 which can travel in the Y direction. A feed apparatus for the substrate samples is provided on the robot arm 5 and can move up and down in the Z direction on the robot arm 5 in the direction indicated by the double-headed arrow 6 shown. The needle head of the feed apparatus 7 is connected to two solution containers 8, 9 via two feed lines 10. CDC13 is stored in the solvent container 8 while the solvent DMSO-d6 is stored in the solvent container 9.

The feed apparatus 7 which is held in a movable manner on the robot arm 5 can be supplied in each case with one of the stored solvents via the feed lines 10.

Sample decks 11 and 12 are shown below the robot arm 5, on which the needle head of the feed apparatus 7 is held so that it can travel in the Y direction. In the view according to FIG. 1, sample deck 11 contains, for example, two levels 11.1 and 11.2, it being possible for the individual sample decks 11 and 12 which hold sample vessels 3.1 or the microtiter plates also comprise more levels than the two levels shown in FIG. 1. To ensure easier access to the respective lower level 11.2 and the substrate sample 3.1 held there, the upper level 11.1 of the sample deck 11 can be provided with passages for the feed apparatus 7 for taking up the substrate samples 3.1. Instead of the two sample decks 11 and 12 shown here, each comprising two levels, it is also possible for further sample decks to be held one on top of the other or side by side, which sample decks can be automatically accessed depending on the dimensioning of the robot arms 4 and 5 of the pipetting system 1.

Sample 3.1 taken up in each case by the feed apparatus 7 is introduced into a filling funnel 13.1 at an injector port, into the line system of the pipetting system 1. The injector port 13 is connected to the valve V2, the pump system 3 containing three further valves V3, V1 and V0. The function of the four valves included in the pipetting system is described in more detail below with reference to the Figure sequence 5.1 to 5.4. The pump system according to FIG. 1 comprises a pump module 20 which includes an HPLC pump which is arranged downstream of an excess pressure control and via which the first valve V0 is fed. Two brake capillaries 18 and 19 are arranged downstream of the first valve V0. The brake capillary 18 serves for building up counter-pressure for the HPLC pump so that the latter achieves its minimum operating counter-pressure, and is connected to an inlet port of the downstream valve V1, while the further brake capillary 19 is used for the solvent DMSO and is connected to another inlet of the valve V1 downstream of the valve V0. One HPLC pump each can also be connected to the brake capillaries 18 and 19 in order to minimize solvent back-mixing during operation.

A solvent changing means 21 is connected upstream of the pump module 20. The solvent changing means 21 is capable of accessing various solvent containers 23 which are denoted individually by the reference numerals 23.1, 23.2, 23.3 and 23.4. The solvent container denoted by 23.1 contains the abovementioned solvent DMSO-d6 and thus corresponds to solvent container 9 according to FIG. 1, while the solvent container having the reference numeral 23.4 corresponds to solvent container 8, which holds chloroform. The solvent container 23.2, which can be accessed using the solvent changing means 21, contains DMSO-d6, while the solvent container 23.3 holds the solvent CHC13. In a design comprising two HPLC pumps, the distributor 21 is not required.

From the injector port 13 or valve V2, the feed line for the substrate sample material dissolved in one of the solvents 8, 9 extends to the flow cell 16. The flow cell 16 is held in a sample head, for example INOVA 400, and has a volume of 120 μl. It is provided with a PEEK feed capillary of 125 μm internal diameter or Teflon feed capillary of 180 μm internal diameter, while a 300 μm Teflon capillary is connected to the flow cell 16 in which the NMR measurement is effected inside the spectrometer, as a discharge line of said flow cell. A waste container 17 is arranged downstream of the outlet of the flow cell 16, it being possible for a further waste container 14 to be coordinated with the injector port 13 or the valve V2. For the sake of completeness, it should be mentioned that, in addition to the feed lines or discharge lines to the solvent containers 23, a waste container 22 may likewise be coordinated with the valve V3.

The modified flushing station (cf. FIG. 6.3) is connected to a pump system 103 via two capillaries 104 and 105, through which protonated solvent, in this case CHC13 and DMSO-h6, can be transported from the two reservoirs 101 and 102.

In the view according to FIG. 2, the time-interleaving of the operating sequences of pipetting needle, pump module and spectrometer containing the flow cell are shown for the processing of two successive samples.

The time sequences required by the respective operations to be carried out during the processing of substrate samples 3.1 are shown with reference to three time axes 24.1, 24.2 and 24.3. The processing steps carried out by means of the feed apparatus 7 are shown along the time axis 24.1, while the processing steps of the pump system 3 are shown along the time axis 24.3. The processing steps taking place in the spectrometer, such as recording of the FID of the substrate samples and recording of an FID of the solvent-filled flow cell, are shown along the time axis according to 24.3. The processing time span for the complete processing of a substrate sample 3.1 is denoted by reference numeral 25 and is 295 s when the solvent chloroform is used, while the time span for processing a sample dissolved in DMSO-d6 is 340 s.

Preparation and dilution of the first sample is carried out at the beginning of sample processing, during the time span 26, which is about 45 s. This is followed by the injection processing step 27.1, by means of which the prepared, i.e. dissolved, mixed and diluted sample is injected into a sample loop 15 of the valve V2. The sample prepared in this manner is injected into the sample loop 15 of the injector port 13 within the further processing step 27.1, which lasts for 45 s. Thereafter, according to time axis 24.2 and over the time span 27.2, the pump module is actuated so that the sample is injected into the spectrometer 24.3 during a time span of 15 or 30 s—depending on the solvent chosen. During the time span 29, plotted along the lower time axis 24.3 for the spectrometer, the substrate sample 3.1 to be measured is present in the flow cell 16 of the spectrometer for 120 s, corresponding to the time span 29. According to the time axis 24.1, flushing of the feed apparatus 7, i.e. of the feed needle and of the injector port, is performed simultaneously and takes about 50 s, denoted by reference numeral 28. Thus, the procedures 28 and 29 take place in different hardware components of the NMR measuring system simultaneously with one another. After completion of the recording 29 of the spectrum, which takes 120 s, a flushing process 30 is carried out with the flow cell 16. This is done by pumping solvent into the flow cell 16, for which purpose the pump module 20 is fed for a time span of 70 or 100 s, depending on the flushing agent used. In the spectrometer 24.3, this is followed by recording of a clean spectrum, which requires 30 s and during which a spectrum of the flushed flow cell 16 is recorded. According to the time axis 24.1, a subsequent sample is simultaneously prepared and diluted in the feed apparatus according to processing step 26 and is injected by the feed apparatus 7 into a pump loop 15 of the injector port 13, according to processing step 27.1. This is followed, analogously to the processing cycle described above, by an injection phase 27.2 by the pump module 20, during which the stored sample is injected into the spectrometer 24.3 and its measured value is recorded during the time span 29.

Depending on the result of the clean spectrum of the flushed flow cell 16, which requires 30 s, the spectrum of the flushed flow cell 16 is compared with its reference spectrum. Depending on the result of the comparison 31 of reference spectrum and clean spectrum, an injection 27.2 of the simultaneously prepared subsequent sample into the flushed flow cell 16 found to be satisfactory is initiated. If, on the other hand, the result of the comparison 31 indicates a divergence between reference spectrum of the solvent used and recorded clean spectrum of the flow cell 16, a further flushing process for the flow cell 16 is effected, which process is denoted by reference numeral 30. As stated above, the time span for all operations for a chloroform-dissolved sample is about 295 s, while the processing time for a sample dissolved in DMSO-d6 is about 340 s.

In the view according to FIG. 3, a common directory structure for communication between the PC controlling the pipetting system and an acquisition computer, for example a SUN workstation is shown.

The common directory tree 32 which can be accessed in common by the computing units 53 and 54 contains directories 33. The common directory tree is searched continuously for flag files by the two PCs in a continuous loop. 33.1 denotes a directory of the sample files which are ready for processing and measurement. 33.2 denotes the directory for sample preparation, while access of the directory 33.3 is a command for injecting the prepared substrate sample 3.1 into the sample loop 15 of the injector port 13. Access of the directory 33.4 indicates readiness of the system for injecting a new sample, while access of the directory 33.5 denotes the command for injection into the flow cell 16. Access of the directory 33.6 denotes the ready message for recording the measured data which are provided by the spectrometer for the dissolved, prepared substrate sample 3.1 contained in the flow cell 16. Access of the directory 33.7 denotes the command for discarding a substrate sample or for flushing the flow cell 16. Stored under 33.8 in the directory tree 32 containing the directories 33 are those files which have to be worked through after completion of a sample measurement, while 33.9 denotes the directory which can be accessed by the two computers 53 and 54 and which stores the files which have to be processed after a complete sample run has been worked through.

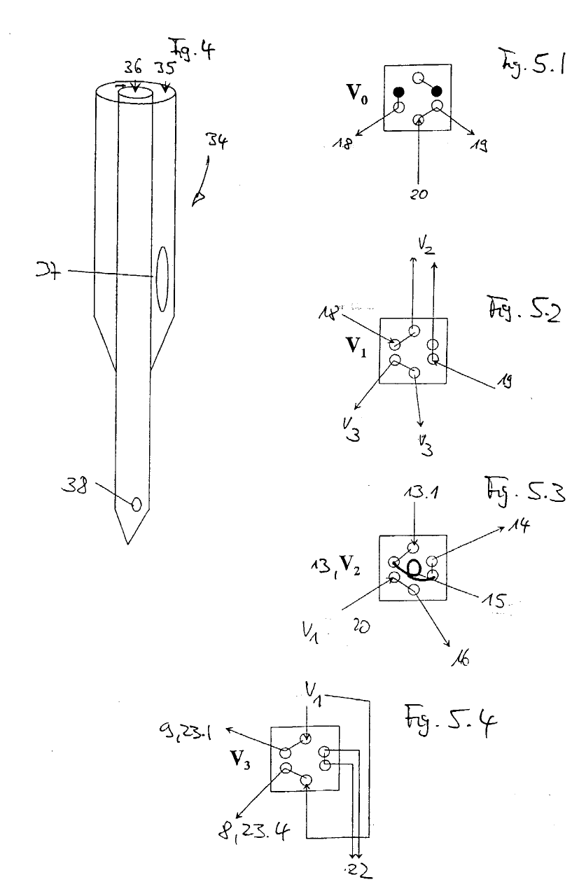

FIG. 4 shows a detailed view of a feed apparatus 7 which can be used.

For example, a needle 34 formed according to the view in FIG. 4 can be held on a needle head according to FIG. 1, which is capable of moving up and down in the Z direction 6. The needle 34 contains two channels, an inner channel 36 for feeding and taking up a liquid volume and an outer air-transporting channel 35 extending in an annular manner around the inner channel 36. The air-transporting channel opens into a vent orifice 37 indicated only schematically here. The channel for liquid transport 36 has a laterally positioned aspiration orifice 38 at the end of the needle 34.

The views according to FIGS. 5.1 to 5.4 show in more detail the valves V0, V1, V2 and V3 which are provided in the pipetting system and by means of which the lines or containers of the pipetting system can be connected to one another.

FIG. 5.1 shows in more detail the valve V0, which is arranged downstream of the pump module 20 and its excess pressure control. The feed line from the pump module is denoted by reference numeral 20, while the two brake capillaries 18 and 19 branch off from the valve V0. The dark dots indicate dummy plugs which are provided in the valve V0. As stated above in connection with the view in FIG. 1, the brake capillaries 18 and 19 are each designed in a solvent-specific manner with respect to flow cross-section and brake capillary length.

FIG. 5.2 shows the valve V1 of the pipetting system 1 in more detail. The abovementioned brake capillaries 18 and 19 join the inputs of valve V1 which are denoted by reference numerals 18 and 19. The two upper outlets of the valve V0 are feed lines to the valve V2, or the two lower outlets of valve V1 are feed lines to the valve V3.

FIG. 5.3 shows the valve V2 of the pipetting system 1, which contains a sample loop 15. A line branches off from the valve V2 and opens into the waste container 14, while 13.1 denotes the feed funnel for the substrate sample to be fed in in each case. The feed line to the flow cell 16 branches off at the lower outlet of the valve V2 or injector port 13, while the feed line of the valve V1 opens into the valve V2 at that inlet of the injector port 13 or of the valve V2 which is denoted by V1.

The view according to 5.4 shows the connections of the inlets and outlets of the valve V3 in more detail. V1 denotes the two feed lines from valve V1, while reference numeral 22 denotes the two feed lines into a waste container 32. The lines which lead to the various solvent containers extend along the side of valve V3, the upper line opening into the container 9 or 23.1, which contains DMSO-d6, while that outlet of valve V3 which is denoted by reference numeral 8 or 23.4 opens into the container 8 containing the solvent chloroform as a deuterated solvent.

FIGS. 6.2 to 6.3 show flushing positions of the feed apparatus which takes up the substrate samples 3.1 in the respective microtiter carriers or bottles of the sample decks.

FIG. 6.1 shows the flushing 41 of the interior of the needle in more detail. The needle 34 introduced into a dip position adjacent to a flushing station 40 is flushed by means of the lateral orifice 38 provided in the needle tip, with the result that a solvent flow 39 emerges from the needle tip and consequently the interior of the needle 34 is flushed.

FIG. 6.2 shows the flushing 42 of the exterior of the needle, the needle 34 dipping into the interior of a flushing station 40. Owing to the resultant flow of flushing agent through the orifice 38, the flushing agent rises at the sides of the flushing station 40 and, following cleaning of the inner surfaces of the needle 34, thus cleans its outer surface and flows away via the outer surface of the flushing station into a collecting container.

FIG. 6.3 shows a flushing agent flow 39 applied to the side of a flushing needle 34. In this embodiment, the flushing agent flow is applied to the needle 34 from outside, resulting in flushing agent flowing spirally around the tip of the needle 34, with the result that the outside of the needle is cleaned.

The flushing cycles of the respective feed apparatus 7, 34 which is shown in FIGS. 6.1 to 6.3 make it possible to remove both solvent residues and substrate sample residues from the feed apparatus, thus ensuring that a sample entrainment from a container containing the samples on changeover to the next sample is ruled out.

FIG. 7 shows a view of a beveled needle 43 with mounted disposable filter tip 44 or 45.

The filter element is provided in the disposable filter in the form of a frit comprising wadding or comprising another porous material and adheres to the outside of the beveled needle 43 by friction. The liquid content of a substrate sample which is contained in the interior of the needle 43 is filtered through the filter member contained in the filter element and emerges in a filtered state at the tip of the filter 45. The filter section 44 or 45 can be made of paper or of plastic, its region widening in the form of a funnel being formed as a wiping aid.

FIGS. 8 (1), (2), (3) show a wiping cycle for a disposable filter element of a beveled needle 43.

The cycle illustrated in the Figure shows that the beveled filter region of the filter element 44, 45 permits an immersion movement of a needle, provided with such a filter and having a bevel, through a slot 46 in a substrate carrier, the needle dipping into the substrate 47 in the direction 48. During the subsequent withdrawal movement, that region of the disposable filter which widens in a funnel-like manner is located underneath the slot 46 of the substrate 47 and remains attached to the substrate during the withdrawal movement of the needle 43. According to FIG. 8 (3), the beveled needle 43 moves out of the slot 46 of the substrate 47 in the withdrawal direction 49, and the disposable filter element 44, 45 remains underneath the substrate and can be received in a waste container.

FIG. 9 shows an alternative embodiment of the solvent transport through the pipetting system according to FIG. 1.

In this configuration, the valves V0, V1 and V2 are contained in the pipetting system as before, whereas a closed circulation 51 is provided for the solvent DMSO and a closed solvent circulation 52 is likewise provided for the further solvent, for example chloroform. In the circulation 51 for the solvent DMSO, a brake capillary 19 specifically tailored to the solvent is provided. The pump module 20 is connected to the corresponding solvent container 9 (cf. FIG. 1) for the solvent DMSO-d6 . A brake capillary 18 for the solvent chloroform, which has a greater length—indicated here by a larger number of brake windings—in comparison with the brake capillary 19 of the closed circulation 51, is provided in the closed circulation 52, which contains a separate pump module 20. The solvent container 8 for the chloroform, which serves as a reservoir and as a discharge tank for the chloroform, is integrated in the solvent circulation 52. From the respective valves V1 and V0, feed lines lead to valve V2, which corresponds to the injector port 13, from which the flow cell 16 is fed with a substrate sample 3.1 prepared with corresponding solvent DMSO or chloroform. Also in this embodiment of the pipetting system according to FIG. 9, a sample loop 15 is contained in the injector port 13 and the filling funnel 13.1 is provided, via which the substrate sample taken up by the feed apparatus 7 is fed to the spectrometer 24.3.

FIG. 10 shows a further possible solution. Instead of the two pump circulations as described in FIG. 9, it is also possible to use two parallel piston pumps 60 and 61. Here too, a parallel version of the solvent systems 62 and 63 is obtained. Otherwise, the configuration according to FIG. 10 essentially resembles the diagram shown in FIG. 9.

List of Reference Numerals

1 Pipetting system

2 Frame

3 Pump module

3.1 Substrate sample

4 Robot arm

5 Robot arm

6 Travel path in Z direction

7 Feed apparatus

8 Solvent container for chloroform

9 Solvent container for DMSO-d6

10 Feed lines

11 Sample deck

11.1 First level

11.2 Second level

12 Further sample deck

13 Injector port

13.1 Filling funnel

14 Waste container

15 Sample loop

16 Flow cell for spectral analysis

17 Waste container

18 First brake capillary

19 Second brake capillary

20 Pump module

21 Solvent changing means

22 Waste container

23 Solvent container

23.1 Solvent container

23.2 Solvent container

23.3 Solvent container

23.4 Solvent container

V0 Valve

V1 Valve

V2 Valve

V3 Valve

24 Parallel processing diagram

24.1 Time axis for feed apparatus

24.2 Time axis for pump module

24.3 Time axis for spectrometer, spectrometer

25 Processing time span for first sample

26 Preparation phase

27 Injection

27.1 Sample loop injection

27.2 Flow cell injection

28 Flow cell flushing

29 Recording spectrum

30 Flow cell flushing

31 Comparison of reference spectrum and clean spectrum for flow cell

32 Directory tree

33 Directory files

33.1 Directory ready for processing

33.2 Preparation directory

33.3 Ready-for-injection message

33.4 Injection execution directory

33.5 Flow cell injection

33.6 Directory for recording sample spectrum

33.7 Record of sample spectrum

33.8 Directory for flow cell flushing

33.9 Release

34 Needle

35 Air transport

36 Liquid transport

37 Vent orifice

38 Lateral aspiration orifice

39 Flushing agent

40 Flushing station

41 Flushing of interior of needle

42 Flushing of exterior of needle

43 Needle with disposable filter attachment

44 Filter section

45 Filter tip

46 Slot

47 Substrate

48 Immersion movement

49 Withdrawal movement

50 Withdrawal path

51 First closed solvent circulation

52 Second closed solvent circulation

53 Control of pipetting system

54 Acquisition computer (SUN workstation)

60 First piston pump

61 Second piston pump

62 First pump system

63 Second pump system

100 Modified flushing station with capillary system

101 First reservoir for flushing solvent, in this case CHC13

102 Second reservoir for flushing solvent, in this case DMSO-h6

103 Pump system

104 First feed line to flushing station

105 Second feed line to flushing station

We claim:

1. A process for preparing and carrying out NMR measurements on substrate samples, solutions of the samples (3) being prepared by means of a pipetting system (1) and being fed to a flow cell (16) for preparation and carrying out of NMR measurements, and it being possible to flush a feed apparatus (7) and the pipetting system (1) with at least one solvent (8, 9), wherein a workstation (54) recording the NMR spectrum of the sample (3.1) and a computer (53) controlling the pipetting system (1) access a common directory tree (32) which contains directories (33.1 to 33.9) with files and flog-files which define the samples and are called up in such a way as to ensure that the directories files (33.1 to 33.9) are worked through in a time-interleaved manner, resulting in a parallel processing of different samples.

2. A process as claimed in claim 1, wherein the preparation steps of the solution and dilution as well as mixing of a first substrate sample (3.1) in a feed apparatus (7, 24.1) are carried out simultaneously with the recording (29) of the spectrum in the spectrometer (24.3).

3. A process as claimed in claim 1, wherein the flushing procedures (28) for feed apparatus (7) and injector port (13, 13.1) are carried out simultaneously with the recording (29) of the spectrum of the preceding substrate sample (3.1) in the spectrometer (24.3).

4. A process as claimed in claim 1, wherein, before a fresh injection (27.1) of a subsequently prepared substrate sample (3) into the flow cell (16), a spectrum of the flushed flow cell (16) is recorded and is compared with a reference spectrum of the flow cell (16).

5. A process as claimed in claim 4, wherein, if the spectra of the flushed flow cell (16) correspond to the reference spectrum, a fresh injection of a subsequent substrate sample (3.1) into the flow cell (16) is effected and, in the event of divergence of the spectra, further flushing (30) of the flow cell (16) is initiated.

6. A process as claimed in one or more of the preceding claims, wherein the solvents (8, 9) are each pumped around in separate, closed circulations (51, 52) in the pipetting system (1) and a separate pump module (20) is coordinated with each solvent circulation (51, 52).

7. A process as claimed in claim 1, wherein the solvents (8, 9, 23.1, 23.4) used are deuterated solvents chloroform and DMSO-d6.

8. An apparatus for preparing and carrying out NMR measurements on substrate samples (3.1), comprising a pipetting system (1) for preparing substrate samples (3.1) and a flow cell (16) for preparation and carrying out of NMR measurements, at least one flushing station being provided for optional flushing of a feed apparatus (7) and of the pipetting system (1) with at least one solvent (8, 9), wherein a directory tree (32) which is accessed jointly by a control computer (53) for the pipetting system (1) and by an acquisition computer (54) for recording the sample spectra permits the substrate samples (3.1) to be worked through in a time-interleaved manner in feed apparatus (7), spectrometer (24.3) and pump module (20), and the substrate samples (3) are held in decks (11, 11.1, 11.2, 12).

9. An apparatus as claimed in claim 8, wherein HPLC pump modules (20) having an excess pressure control are used for shortening the injection times (27.1, 27.2) of the samples into the sample loop (15) or into the flow cell (16).

10. An apparatus as claimed in claim 8, wherein brake capillary zones (18, 19) specific for each of the solvents (8, 9) are arranged downstream of the pump module (20).

11. An apparatus as claimed in claim 8, wherein the sample decks (11, 12) have at least two levels (11.1, 11.2) into which containers holding substrate samples (3.1) are led, passages for the feed apparatus (7) being provided between the levels (11.1, 11.2).

12. An apparatus as claimed in claim 8, wherein a flushing station (40) for an interior flushing and an exterior flushing of the needle (34), having a solvent flow (39) to be applied, is provided.

13. An apparatus as claimed in claim 8, wherein a disposable filter element (44, 45) which is wipable during a vertical movement (49, 50) of the feed apparatus (7) is provided on the needle (43) taking up the substrate sample (3.1).

14. An apparatus as claimed in claim 8, wherein the solvents (8, 9) each circulate in closed solvent circulations (51, 52), with each of which pump modules (20) and brake capillaries (18, 19) differently dimensioned in a solvent-specific manner are coordinated.
